(19) United States
(12) Patent Application Publication
(10) Pub. No.: US 2019/0315193 A1
(43) Pub. Date: Oct. 17, 2019

(54) METHOD FOR INCREASING A TEMPERATURE OF A VEHICLE INTERIOR, AND VEHICLE FOR IMPLEMENTING THE METHOD

(71) Applicant: Audi AG, Ingolstadt (DE)

(72) Inventors: Markus Ruf, Waldstetten (DE); Kai Müller, Bretzfeld (DE); Michael Brechter, Möckmühl (DE); Michael Graebner, Öhringen (DE)

(21) Appl. No.: 16/376,951

(22) Filed: Apr. 5, 2019

(30) Foreign Application Priority Data
Apr. 12, 2018 (DE) 10 2018 205 555.6

(51) Int. Cl. B60H 1/02; B60H 1/00

(52) U.S. Cl. CPC B60H 1/02; B60H 1/00392; B60H 2001/2253; H01M 2250/405; H01M 2250/20

(57) ABSTRACT

The disclosure relates to a method for increasing a temperature of a vehicle interior of a vehicle from a low temperature value to an increased temperature value, wherein the vehicle has a fuel cell system with a fuel cell stack and a compressor connected with the fuel cell stack at the cathode side, comprising: drawing in cathode gas via the compressor, and compressing and heating the drawn-in cathode gas. At least a portion of a cathode gas mass flow of the heated cathode gas is directed into the vehicle interior, and the temperature of the vehicle interior is raised to the increased temperature value. Moreover, the disclosure relates to a vehicle for implementing the method.

### CROSS-REFERENCE TO RELATED APPLICATION

This application claims priority to Germany Application No. 10 2018 205 555.6, filed Apr. 12, 2018, the entire contents of which are hereby incorporated by reference.

### BACKGROUND

### Technical Field

The disclosure relates to a method for increasing a temperature of a vehicle interior of a vehicle from a low temperature value to an increased temperature value, wherein the vehicle has a fuel cell system with a fuel cell stack and a compressor connected at a cathode side with said fuel cell stack. The method comprises drawing in cathode gas via the compressor, and compressing and heating the drawn-in cathode gas.

The disclosure moreover relates to a vehicle for implementing the aforementioned method, with a battery; with a fuel cell system having a fuel cell stack; and with a compressor fluidically connected at the cathode side with said fuel cell stack via a cathode supply line.

### Description of the Related Art

DE 10 101 914 A1 describes a device and a method for a fuel cell system vehicle with a compressor which draws in ambient air, compresses it, and supplies this heated ambient air to a cold air-process climate control system or cold air-process heat pump in order to cool a vehicle interior. In order to cool the vehicle interior, the ambient air previously heated by the compressor is thus cooled again by an expander.

Moreover, PTC heaters for heating the vehicle interior are known from the prior art. However, an additional component and additional installation space in the vehicle are required for heating by PTC heaters. This results in a cost increase in the manufacturing of the vehicle.

### BRIEF SUMMARY

Embodiments of the present invention provide a more energy efficient method and a vehicle which can be heated more energy-efficiently.

In particular, a more energy efficient method is achieved in that at least a portion of a cathode gas mass flow of the heated cathode gas is directed into the vehicle interior, and in that the temperature of the vehicle interior is raised to the increased temperature value. A method for heating the vehicle interior is thereby achieved which makes use of components, such as the compressor, which are already present in the fuel cell system. Moreover, the cathode gas heated upon compression by the compressor is energy-efficiently used for heating the vehicle interior.

In order to further increase the energy efficiency of the method, it is advantageous if the cathode gas mass flow is only directed into the vehicle interior until a predetermined or predeterminable increased temperature value is reached. In an advantageous embodiment, a sensor that determines a real temperature value and relays it to a control unit, which compares the real temperature value with the predetermined or predeterminable increased temperature value, is provided for this purpose.

In order to be able to also heat the vehicle when it is stationary, the method additionally comprises the following:
starting a battery operation in which power is supplied to the vehicle exclusively by a battery, and
operating the compressor by the battery.

This allows for heating of the vehicle interior when the vehicle is not or is not yet operated with the fuel cell system. In an alternative embodiment, in order to raise a temperature in the fuel cell stack, it is provided that at least a portion of the cathode gas mass flow is directed into or to the fuel cell stack. This enables preheating of the fuel cell stack at low or lower external temperatures, i.e., in particular given a cold start.

Moreover, the method comprises the following: starting fuel cell operation by supplying fuel at the anode side, and supplying at least another portion of the cathode gas mass flow to the fuel cell stack at the cathode side. Consequently, in an advantageous embodiment, the method switches between a battery operation, in which the power is supplied to the vehicle exclusively by the battery, and a fuel cell operation, in which the vehicle is operated by the fuel cell system.

It is furthermore provided, that, if the temperature in the vehicle interior does not correspond to the predetermined or predeterminable higher temperature value, at least a portion of the cathode gas mass flow of the heated cathode gas is directed into the vehicle interior so that the temperature of said vehicle interior is raised to the increased temperature value. In an alternative embodiment, the method may also have only a battery operation or only a fuel cell operation.

In order to improve the energy efficiency of the method, it is advantageous if a cathode gas mass flow is no longer directed into the vehicle interior as soon as the battery operation or the fuel cell operation is ended. Battery operation may be ended by turning off the vehicle, i.e., by interrupting the voltage supply by the battery, or by starting fuel cell operation, i.e., by supplying fuel into the anode chambers of the fuel cell stack. The fuel cell operation may in turn take place by turning off the vehicle, i.e., by interrupting the anode-side supply of fuel into the fuel cell stack, and/or by starting the battery operation, by supplying power to the vehicle exclusively by the battery.

It is particularly advantageous if the other portion of the cathode gas mass flow is complementary to the portion of the cathode gas mass flow that is supplied to the vehicle interior. In fuel cell operation, it is thus preferred if one portion of the cathode gas mass flow is directed to the vehicle interior, and another portion of the cathode gas mass flow complementary thereto is directed to the cathode chambers of the fuel cell stack. In an advantageous embodiment, the portion and the other portion of the cathode gas mass flow are variable and are controlled by a control unit such that the fuel cell system generates a predetermined or predeterminable voltage, and/or such that the temperature of the vehicle interior is raised to the predetermined or predeterminable increased temperature value.

In this context, it is advantageous if a throughput of the compressor is adapted to a predetermined or predeterminable value, i.e., is increased or decreased. In fuel cell operation in particular, an increase in throughput may be necessary. Upon reaching the increased temperature value, the throughput of the compressor may possibly be reduced again.

Moreover, in order to achieve a certain increased temperature value, it is advantageous if an auxiliary mass flow is mixed with the cathode gas mass flow until the predetermined or predeterminable increased temperature value is reached in the vehicle interior.

A vehicle which can be heated more energy-efficiently is achieved by a vehicle of the aforementioned type in that an interior line that is fluidically connected with the cathode supply line and leads into the vehicle interior is present downstream of the compressor to supply at least a portion of a heated cathode gas mass flow into said vehicle interior. For heating the vehicle interior, this enables an efficient utilization of components which are already present in the fuel cell system. In addition, components such as a PTC heater may be dispensed with, and costs and installation space may thus be saved.

In order to control or adjust the portion of the cathode gas mass flow that is supplied to the interior, it is advantageous if a control element is associated with the interior line. The control element may be formed as a valve or as a flap. The control element is moreover preferably controllable via a control unit. The control unit in this case preferably controls a throughput of the compressor and/or a portion of the cathode gas mass flow in the interior line and/or a portion of the cathode gas mass flow in the cathode supply line.

In order to better set or reach the predetermined or predeterminable increased temperature value in the vehicle interior, it is advantageous if an air supply line is present that is fluidically connected with the interior line, and which is designed to admix an auxiliary mass flow made up of ambient air with the portion of the cathode gas mass flow. In an advantageous embodiment, the portions of the cathode gas mass flow in the mixture are controlled by the control unit.

### BRIEF DESCRIPTION OF THE SEVERAL VIEWS OF THE DRAWINGS

FIG. 1 is a schematic illustration of a fuel cell system for a vehicle for increasing a temperature in a vehicle interior.

### DETAILED DESCRIPTION

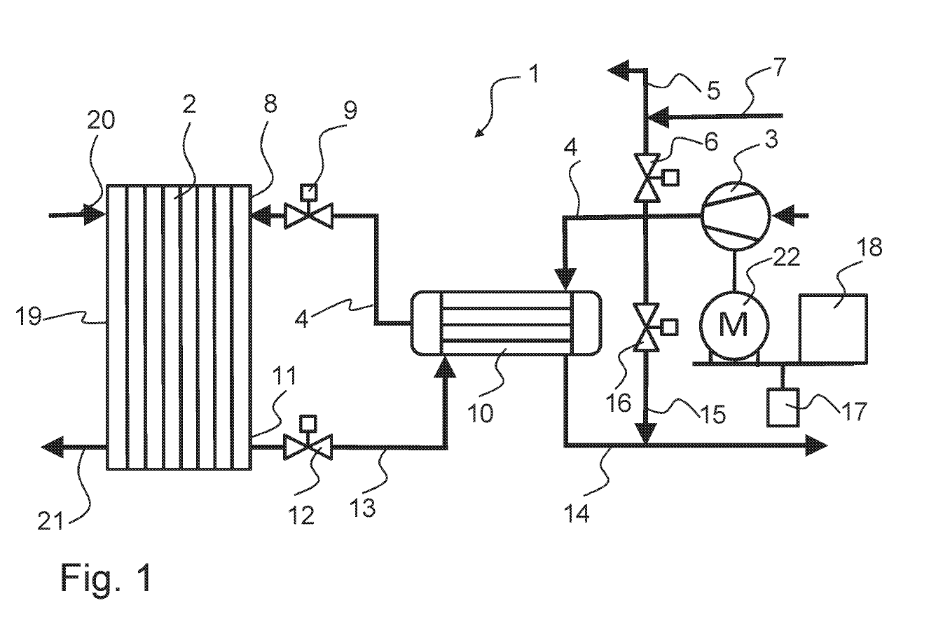

FIG. 1 shows a fuel cell system 1 for a vehicle, wherein the fuel cell system 1 is suitable for raising a temperature of a vehicle interior from a low temperature value to an increased temperature value, and for driving the vehicle. The fuel cell system 1 in this case comprises a fuel cell stack 2 whose cathode chambers can be sealed at the cathode intake side 8 by a first actuator 9 formed as a first butterfly valve, and are connected via a cathode supply line 4 with a humidifier 10. The cathode chambers can be sealed at the cathode output side 11 by a second actuator 12 formed as a second butterfly valve, and are connected via a discharge line 13 with the humidifier 10. The fuel cell system 1 furthermore comprises a compressor 3 that can be driven via a drive means or device 22, via which compressor 3 dry cathode gas as a cathode gas mass flow can be supplied to the humidifier 10. Furthermore, an exhaust line 14 is associated with the humidifier 10, wherein between the humidifier 10 and the compressor 3, the cathode supply line 4 is connected with the exhaust line 14 via a system bypass line 15. An adjustable or controllable bypass actuator 16 is associated with the system bypass line 15, which bypass actuator 16 is designed to have an opening angle of between 5% and 40%, in particular between 10% and 30%. The bypass actuator 16 is in this case formed as a bypass flap and is connected to the control unit 18 wirelessly or via wire. Finally, a battery 17 is provided which, in addition to the fuel cell system 1, supplies power to the vehicle.

Downstream of the compressor 3, an interior line 5 that is fluidically connected with the cathode supply line 4 and leads into a vehicle interior is present to supply at least a portion of a cathode gas mass flow that is compressed by the compressor 3, and therefore heated, into the vehicle interior. A control element 6 formed as a valve is in this case associated with the interior line 5, which control element 6 is connected to the control unit 18 wirelessly or via wire to control or adjust the portion of the cathode gas mass flow that is supplied to the vehicle interior.

At the anode side 19, an anode supply line 20 for supplying fuel and an anode exhaust line 21 for removing unreacted fuel are associated with the fuel cell stack 2.

In order to be able to better set or reach the predetermined or predeterminable increased temperature value in the vehicle interior, an air supply line 7 that is fluidically connected with the interior line 5 is additionally provided, which air supply line 7 is designed to admix an auxiliary mass flow made up of ambient air with the portion of the cathode gas mass flow.

The method for increasing a temperature of a vehicle interior of a vehicle with the above-described device in this case comprises the following: First, a battery operation of the vehicle is started, in which power is supplied to the vehicle exclusively by the battery 17. In battery operation, fuel is not supplied to the fuel cell system 1. If the temperature in the vehicle interior does not correspond to the predetermined or predeterminable increased temperature value, the compressor 3 is operated by the battery 17. Cathode gas is drawn in by a suction means (not shown) and compressed by the compressor 3, and thus heated. At least a portion of the cathode gas mass flow heated in such a manner is directed via the interior line 5 into the vehicle interior, and the temperature of the vehicle interior is thus increased. Moreover, ambient air is drawn into the air supply line 7 as required and admixed with the cathode gas mass flow in the interior line 5 in order to be able to reach the predetermined temperature value better and/or more precisely. The cathode gas mass flow is supplied until the battery operation is ended, for example by turning off the vehicle or by starting a fuel cell operation, or until the predetermined or predeterminable increased temperature value is reached.

Further, in order to be able to drive with the vehicle, the fuel cell operation is started by supplying fuel to the anode chambers 19 and supplying at least another portion of the cathode gas mass flow to the cathode chambers 8. If the temperature prevailing in the vehicle interior does not correspond to the predetermined or predeterminable higher temperature value, the portion of the cathode gas mass flow is directed via the interior line 5 from the compressor 3 into the vehicle interior, whereas the other portion of the cathode gas mass flow is directed into the cathode chambers 8 of the fuel cell stack 2. The other portion of the cathode gas mass flow is in this case conducted across the humidifier 10, moistened there, and is subsequently directed to the cathode chambers 8 of the fuel cell stack 2. The other portion of the cathode gas mass flow is in this case complementary to the portion of the cathode gas mass flow that is supplied to the vehicle interior. In this context, it may be necessary to increase a throughput of the compressor 3 and to reduce it again when the increased temperature value is reached.

The supply of the cathode gas mass flow into the vehicle interior in this case again takes place until the fuel cell operation is ended or until the predetermined or predeterminable increased temperature value is reached. The fuel cell operation is preferably ended by interrupting the supply of fuel.

In general, in the following claims, the terms used should not be construed to limit the claims to the specific embodiments disclosed in the specification and the claims, but should be construed to include all possible embodiments along with the full scope of equivalents to which such claims are entitled.

1. A method for increasing a temperature of a vehicle interior of a vehicle from a low temperature value to an increased temperature value, wherein the vehicle has a fuel cell system with a fuel cell stack and a compressor connected with the fuel cell stack at a cathode side, the method comprising:
drawing in cathode gas via the compressor;
compressing and heating the drawn-in cathode gas; and
directing at least a portion of a cathode gas mass flow of the heated cathode gas into the vehicle interior such that the temperature of the vehicle interior is raised to the increased temperature value.

2. The method according to claim 1, wherein the at least a portion of the cathode gas mass flow is only directed into the vehicle interior until the increased temperature value is reached.

3. The method according to claim 1, further comprising:
starting a battery operation in which power is supplied to the vehicle exclusively by a battery; and
operating the compressor by the battery.

4. The method according to claim 3, further comprising:
starting a fuel cell operation by supplying fuel at an anode side; and
supplying at least another portion of the cathode gas mass flow to the fuel cell stack at the cathode side.

5. The method according to claim 4, wherein the at least a portion of the cathode gas mass flow is no longer directed into the vehicle interior as soon as the battery operation or the fuel cell operation is ended.

6. The method according to claim 5, wherein the other portion of the cathode gas mass flow is complementary to the portion of the cathode gas mass flow that is supplied to the vehicle interior.

7. The method according to claim 1, wherein an auxiliary mass flow is mixed with the at least a portion of the cathode gas mass flow until the increased temperature value in the vehicle interior is reached.

8. A vehicle, comprising:
a battery;
a fuel cell system having a fuel cell stack;
a compressor fluidically connected with the fuel cell stack at a cathode side via a cathode supply line; and
an interior line that is fluidically connected with the cathode supply line and leads into a vehicle interior and that is present downstream of the compressor to supply at least a portion of a heated cathode gas mass flow into the vehicle interior, and
wherein the vehicle is configured to draw in cathode gas via the compressor, compress and heat the drawn-in cathode gas, and supply the at least a portion of the heated cathode gas mass flow into the vehicle interior such that a temperature of the vehicle interior is raised to an increased temperature value.

9. The vehicle according to claim 8, wherein a control element for controlling or adjusting the at least a portion of the heated cathode gas mass flow that is supplied to the vehicle interior is associated with the interior line.

10. The vehicle according to claim 8, wherein an air supply line is present that is fluidically connected with the interior line and that is designed to admix an auxiliary mass flow made up of ambient air with the at least a portion of the heated cathode gas mass flow.
